(19) United States
(12) Patent Application Publication
(10) Pub. No.: US 2011/0231040 A1
(43) Pub. Date: Sep. 22, 2011

(54) USE OF DISCONTINUOUS PULSE WIDTH MODULATION FOR AN INVERTER COUPLED TO AN ELECTRIC MOTOR FOR A VEHICLE

(75) Inventors: Steven E. Schulz, Torrance, CA (US); Goro Tamai, West Bloomfield, MI (US); Lan Wang, Troy, MI (US); Karl Andrew Sime, Mason, MI (US); Silva Hiti, Redondo Beach, CA (US); Brian A. Welchko, Torrance, CA (US)

(73) Assignee: GM GLOBAL TECHNOLOGY OPERATIONS, INC., DETROIT, MI (US)

(21) Appl. No.: 12/725,543

(22) Filed: Mar. 17, 2010

(51) Int. Cl. G06F 19/00

(52) U.S. Cl. 701/22; 180/65.275

(57) ABSTRACT

A method for controlling an inverter coupled to an electric motor for a vehicle includes generating a discontinuous PWM signal for the inverter when a torque of the electric motor and a speed of the electric motor are substantially zero, and when at least one predetermined vehicle condition is met.

### TECHNICAL FIELD

The present invention relates, generally, to a vehicle having an electric motor, and more specifically, to a method for controlling pulse width modulation for an inverter used with the electric motor.

### BACKGROUND OF THE INVENTION

Recent advances in technology have led to the use of electric motor/generators to provide all or a portion of the power used to drive a vehicle in order to improve the vehicle fuel efficiency and/or driving range. An inverter is typically used with the electric motor to convert DC power to an AC power input in order to operate the electric motor. A discontinuous pulse width modulation signal (PWM) for the inverter may be used to decrease switching losses when the electric motor has zero speed and zero torque. However, changing the control signal for the inverter to a discontinuous PWM signal every time the electric motor is at zero speed and zero torque decreases the response time of the motor.

### SUMMARY OF THE INVENTION

A method for controlling an inverter coupled to an electric motor for a vehicle is provided. The method includes generating a discontinuous PWM signal for the inverter when either the torque of the electric motor is greater than a predetermined torque value or the speed of the electric motor is above a predetermined speed value. A discontinuous PWM signal is also generated when the torque of the electric motor and the speed of the electric motor are substantially zero and at least one predetermined vehicle condition is met.

The at least one predetermined vehicle condition includes at least one of a transmission is in a highest fixed gear, and an engine is off and the vehicle speed is substantially zero. Additionally, substantially zero torque is less than one percent of a maximum torque for the motor and substantially zero speed is less than one percent of a maximum speed for the motor.

The method may further include generating a continuous PWM signal for the inverter when one of the torque of the electric motor is less than the predetermined torque value and is greater than substantially zero and the speed of the electric motor is less than the predetermined speed value and is greater than substantially zero.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view illustration of a vehicle having an electrically variable transmission and an electric motor;

FIG. 2 is a schematic illustration of an inverter for the electric motor and the vehicle of FIG. 1;

FIG. 3 is a schematic graphical illustration of a control signal for the inverter for the vehicle of FIG. 1; and

FIG. 4 is a flow chart of a method for controlling a signal for the inverter for the vehicle of FIG. 1.

### DESCRIPTION OF THE PREFERRED EMBODIMENTS

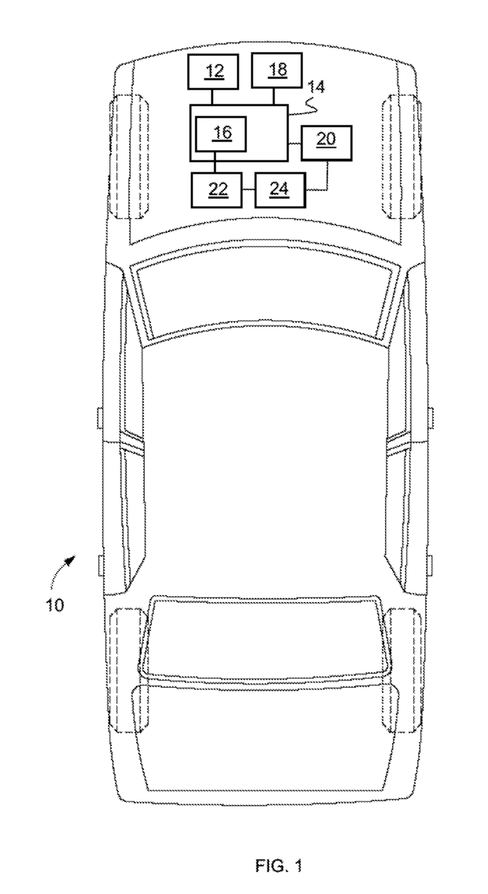

Referring to the Figures, wherein like reference numbers refer to the same or similar components throughout the several views, FIG. 1 schematically illustrates a vehicle 10 including an engine 12, a transmission 14, and at least one motor 16. The motor 16 may be a motor/generator where the power generated by the motor 16 may drive the transmission 14 or be stored in a battery 18 for later use. A drivetrain (not shown) may also be connected to the transmission 14.

The transmission 14 is preferably a hybrid transmission 14 having one or more modes of operation. A transmission 14 having multiple operating moves may operate in standard, electric or hybrid modes. In standard operation mode, the transmission 14 is driven by the engine 12. Under certain vehicle 10 conditions, typically when the power demand for the vehicle 10 is low, the engine 12 may be turned off and the power required to drive the transmission 14 may be provided by the motor 16, this is known as the electric operating mode of operation. In hybrid operating mode the engine 12 provides power, and the motor 16 is controlled to function as a motor or a generator. In hybrid operating mode the transmission 14 may respond similar to a continuously variable transmission to provide smooth operation of the vehicle 10 over a wide range of speeds. However, once the vehicle 10 has reached a cruising speed, where little or no acceleration is required, the transmission 14 operates in a fixed gear. The fixed gear is selected based upon the cruising speed of the vehicle 10 and the particular transmission 14 and gear ratios provided for a particular vehicle 10. Typically, while cruising at high speeds the highest gear available for a particular transmission 14 is selected.

An electronic control unit (ECU) 20 is connected to the engine 12, the motor 16 and the transmission 14 for controlling various vehicle functions, including the operating mode for the transmission 14. The ECU 20 may also be connected to various other components, such as, but not limited to, sensors and control modules useful for controlling the vehicle 10. An inverter 22 and a controller 24 are also connected to the ECU 20 for controlling operation of the motor 16. The controller 24 receives data regarding the inverter 22 and the motor 16. For example, sensors (not shown) within the motor 16 report the operating speed and torque of the motor 16 to the controller 24. Additionally, the controller 24 may receive vehicle 10 data from the ECU 20.

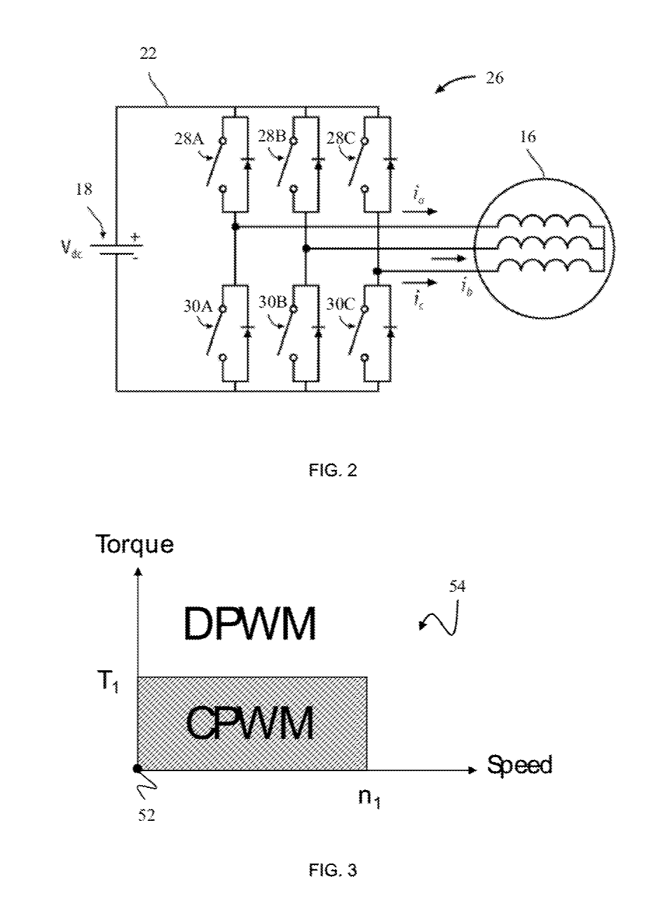

Referring to FIG. 2, a schematic illustration of the motor 16 and the inverter 22 is shown. The controller 24 (shown in FIG. 1) inputs a control signal to the inverter 22 based on the data from the motor 16, and the ECU 20. The inverter 22 receives DC power input from the battery 18 and outputs AC power to the motor 16.

The inverter 22 includes a three-phase circuit 26, where three-phase outputs, iₐ, i_{b}, i_{c} from the inverter 22 are connected to the motor 16. The battery 18 provides a voltage source V_{dc} to the inverter 22. The inverter 22 includes a plurality of switches 28A, 28B, 28C, 30A, 30B and 30C to convert the DC power input from the battery 18 into a three-phase AC power output iₐ, i_{b}, i_{c} which can be utilized by the motor 16. Three of the switches 28A, 28B, 28C, are connected to the positive output of the battery 18 and three of the switches 30A, 30B and 30C are connected to the negative output of the battery 18. Additionally, the plurality of switches 28A, 28B, 28C, 30A, 30B and 30C are connected to form three pairs having three outputs iₐ, i_{b}, i_{c} from the inverter 22. That is, the output of switch 28A is connected to the output of switch 30A to form the output iₐ from the inverter 22. The output of switch 28B is connected to the output of switch 30B to form the output i_{b} from the inverter 22. Finally, the output of 28C is connected to the output of switch 30C to form the output i_{c} from the inverter 22. DC power from the battery 18 is converted into a three-phase output iₐ, i_{b}, i_{c} by repeatedly opening and closing the plurality of switches 28A, 28B, 28C, 30A, 30B and 30C based upon the signals from the controller 24 (shown in FIG. 1).

Referring to FIGS. 1 and 3, during operation of the vehicle 10 the battery 18 provides DC power to the inverter 22 which in turn converts the DC power to an AC output for use by the motor 16. The controller 24 may generally utilize a continuous pulse width modulated (PWM) signal to control the switching of the inverter 22. The continuous pulse width modulated (PWM) signal reduces torque ripple that is produced from current distortions when using a discontinuous PWM. However, when the motor 16 is experiencing high torque and speed, the current distortions produced by other sources are greater than those produced by a discontinuous PWM signal. Therefore, a discontinuous PWM signal may be utilized to reduce switching losses without the problem of the associated current distortion. As a result, when the motor 16 is operating below a predetermined speed n₁ and below a predetermined torque T₁ the control signal for the inverter 22 is a continuous PWM signal, as indicated on graph 54 comparing the speed and torque of the motor 16 with the control signal from the inverter 22. When the motor 16 is operating above the predetermined speed n₁ or the predetermined torque T₁, the inverter 22 is operated with a discontinuous PWM, indicated on the graph 54.

When the motor 16 is at near zero torque and speed, torque ripple is not a problem and a discontinuous PWM signal may be used for the inverter 22 at this point as well, as indicated at 52 on the graph 54. However, when the vehicle 10 is operating the motor 16 may frequently reach zero torque and speed momentarily. Every time the control signal for the inverter 22 is changed there may be a delay in operation of the motor 16. In most circumstances the delay in operation of the motor 16 is not noticeable. However, if the control signal for the inverter 22 is frequently changing between a continuous PWM and a discontinuous PWM (i.e. when the motor torque and speed are momentarily substantially zero) the performance of the motor 16 may be affected.

Therefore, use of discontinuous PWM signal to control the inverter 22 should be limited to vehicle 10 situations where the speed and torque of the motor 16 are substantially zero for a sufficient time to take advantage of the reduction in switching losses. Several situations may exist in which the motor 16 is at substantially zero actual or commanded torque and speed for a sufficient amount of time that the reduction in switching losses is a greater advantage than the small delay in motor 16 operation. For example, when the vehicle 10 is in electric mode, i.e. the engine 12 is off, and the vehicle 10 has substantially zero speed. In this instance there is no demand on the motor 16. The vehicle 10 may be in electric mode, with no speed in a number of occurrences including when the vehicle 10 is in park, neutral, or at a stop. Another instance when utilizing discontinuous PWM is advantageous is when the vehicle 10 is at cruising speed and the transmission 14 is operating in fixed gear. For example, when the transmission 14 is in the highest fixed gear available, such as cruising at highway speeds.

Substantially zero torque and speed of the electric motor 16 would be a torque or speed that is less than one percent of the maximum operating torque and speed for a particular motor 16. Additionally, speed of the vehicle 10 is substantially zero when the speed is less than one mile per hour.

Alternatively, the electric motor 16 may also be commanded using a discontinuous PWM when the torque is substantially zero and the speed of the electric motor 16 is below a predetermined speed threshold n₂. When the electric motor 16 operates at discontinuous PWM when the speed of the motor 16 is near zero than the predetermined speed threshold n₂ would equal zero.

References to substantially zero torque of the electric motor 16 refer to both substantially zero actual torque and command torque. Substantially zero actual torque occurs when the estimated torque value of the electric motor 16 is less than one percent of the maximum operating torque. Substantially zero command torque occurs when the electric motor 16 is below a predetermined torque value that is sufficiently low enough that the electric motor 16 may operated as if there was zero torque. One skilled in the art would know the appropriate predetermined torque value for a particular electric motor 16 to operate at substantially zero command torque.

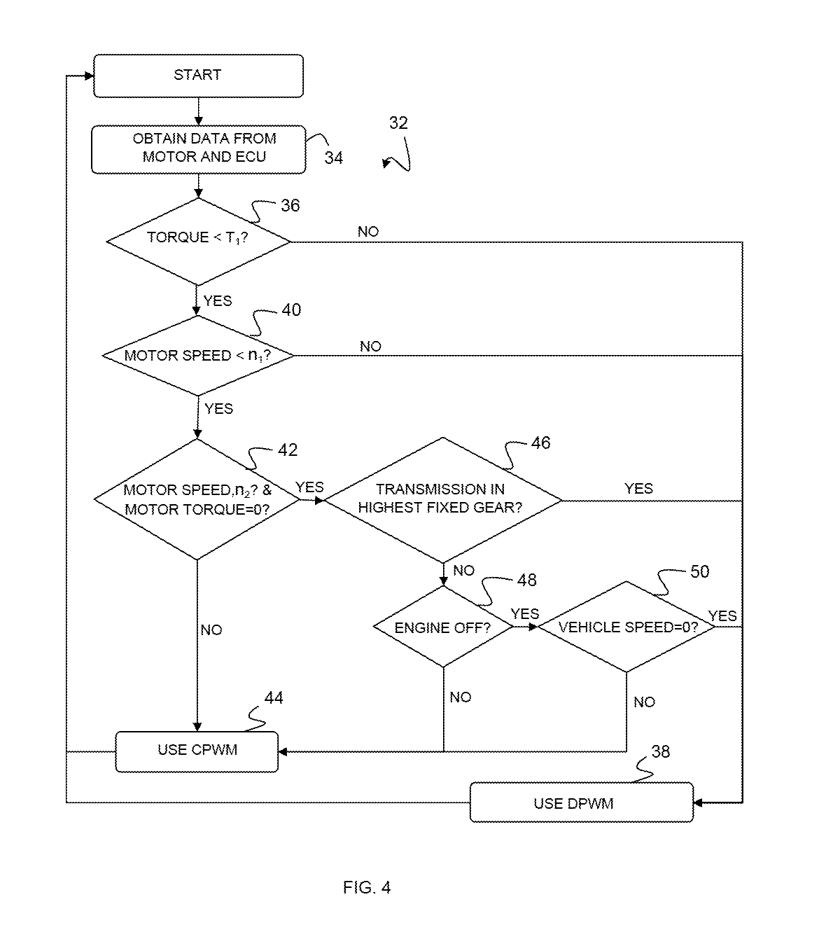

FIG. 4 is a flow diagram 32 which schematically illustrates one embodiment of a method for controlling an inverter 22 for the vehicle 10 with the electric motor 16. The controller 24 for the inverter 22 gathers data from the motor 16 and from the ECU 20, step 34. The data gathered by the controller 24 may include the vehicle speed, transmission operating mode, motor speed, motor torque and other vehicle 10 data that may be required. The controller 24 then compares the torque of the motor 16 to the predetermined torque value T₁, step 36. If the motor 16 torque is greater than or equal to the predetermined torque value T₁ the controller 24 utilizes a discontinuous PWM to control the motor 16, step 38.

If the motor 16 torque is less than the predetermined torque value T₁ the controller 24 compares the actual speed of the motor 16 to the predetermined motor speed n₁, step 40. If the motor 16 speed in greater than or equal to the predetermined motor speed n₁ than the controller 24 utilizes a discontinuous PWM to control the motor 16, step 38. If the motor speed is less than the predetermined motor speed n₁ the controller 24 checks to if the actual torque of the motor 16 is substantially zero and the actual speed of the motor 16 is below the predetermined speed threshold n₂, step 42. If either of the motor torque is not near zero or the speed is above the predetermined speed threshold n₂, then the controller 24 sends a continuous PWM signal to the inverter 22, step 44.

If both the motor torque is near zero and the motor speed is below the predetermined speed threshold n₂, then the controller 24 assesses the data from the ECU 20 to find out if the transmission 14 is in the highest fixed gear available, step 46. If the transmission 14 is in the highest fixed gear available, the controller 24 instructs the inverter 22 with a discontinuous PWM, step 38. If the transmission 14 is not in the highest fixed gear the controller 24 assesses the data from the ECU 20 again to find out if the engine 12 is in the off position, i.e. checks if the vehicle 10 is operating in electric mode, step 48. If the engine 12 is on (i.e. the vehicle 10 is not in electric mode) the controller 24 instructs the inverter 22 with a continuous PWM signal, step 44. If the engine 12 is off, the controller 24 then assesses the speed of the vehicle 10 to confirm the vehicle 10 has zero speed, step 50. If the vehicle 10 is moving, a continuous PWM signal is sent to the inverter 22, step 44, and if the vehicle is not moving, then a discontinuous PWM is sent to the inverter 22, step 38.

The above embodiment discloses using a discontinuous PWM when a motor 16 torque and speed are above predetermined levels, or when the motor 16 speed and torque are zero and other predetermined vehicle 10 conditions are met. Although the predetermined vehicle 10 conditions disclosed include operating in the highest transmission gear, or when the engine is off and the vehicle is at a stop other vehicle 10 conditions may be selected for controlling the inverter 22 with a discontinuous PWM signal. One skilled in the art would be able to select the appropriate vehicle conditions in which to control the inverter 22 with a discontinuous PWM.

While the best modes for carrying out the invention have been described in detail, those familiar with the art to which this invention relates will recognize various alternative designs and embodiments for practicing the invention within the scope of the appended claims.

1. A method for controlling an inverter coupled to an electric motor for a vehicle comprising:
generating a discontinuous PWM signal for the inverter when a torque of the electric motor is substantially zero, a speed of the electric motor is below a predetermined speed threshold and at least one predetermined vehicle condition is met.

2. The method of claim 1, wherein the vehicle is powered by either the motor or an engine, and wherein the at least one predetermined vehicle condition includes at least one of a transmission is in a highest fixed gear, and the engine is off and the vehicle speed is substantially zero.

3. The method of claim 1, wherein the substantially zero torque is less than one percent of a maximum torque for the motor.

4. The method of claim 1, wherein the torque of the electric motor is one of actual and commanded torque of the electric motor.

5. The method of claim 1, wherein the speed of the electric motor is substantially zero.

6. The method of claim 5, wherein substantially zero speed is less than one percent of a maximum speed for the motor.

7. The method of claim 1, further including:
generating a continuous PWM signal for the inverter when one of the torque of the electric motor is less than a predetermined torque value and is greater than substantially zero and the speed of the electric motor is less than a predetermined speed value and is greater than the predetermined speed threshold.

8. The method of claim 7, further including:
generating a discontinuous PWM signal for the inverter when one of the torque of the electric motor is greater than the predetermined torque value and the speed of the electric motor is greater than the predetermined speed value.

9. A method for controlling an inverter coupled to an electric motor for a vehicle comprising:
generating a discontinuous PWM signal for the inverter when one of:
a torque of the electric motor is greater than a predetermined torque value;
a speed of the electric motor is above a predetermined speed value; and
the torque of the electric motor and the speed of the electric motor are substantially zero and at least one predetermined vehicle condition is met.

10. The method of claim 9, wherein the vehicle is powered by either the motor or an engine through a transmission, and wherein meeting the at least one predetermined vehicle condition includes at least one of the transmission is in a highest fixed gear, and the engine is off and the vehicle speed is zero.

11. The method of claim 9, wherein the torque of the electric motor is one of actual and commanded torque of the electric motor.

12. The method of claim 9, wherein zero torque is less than one percent of a maximum torque for the motor.

13. The method of claim 9, wherein zero speed is less than one percent of a maximum speed for the motor.

14. The method of claim 9, further including:
generating a continuous PWM signal for the inverter when one of the torque of the electric motor is less than the predetermined torque value and is greater than zero and the speed of the electric motor is less than the predetermined speed value and is greater than zero.
